(19) United States
(12) Patent Application Publication
(10) Pub. No.: US 2026/0084715 A1
(43) Pub. Date: Mar. 26, 2026

(54) Method and Apparatus for Specializing a Trained Machine Learning Model

(71) Applicant: Robert Bosch GmbH, Stuttgart (DE)

(72) Inventor: Houssem Boulahbal, Leonberg (DE)

(21) Appl. No.: 19/334,892

(22) Filed: Sep. 21, 2025

(30) Foreign Application Priority Data
Sep. 24, 2024 (DE) 10 2024 209 139.1

(51) Int. Cl. B60W 60/00; G06N 20/00

(52) U.S. Cl. CPC B60W 60/001; G06N 20/00

(57) ABSTRACT

A method is disclosed for specializing a trained machine learning model for providing a driving function of a vehicle or a control function of a machine. The method includes (i) providing the trained machine learning model, which is trained on the basis of driving data from the vehicle or control data from the machine to perform the driving function or the control function, and which is extended by a storage module, wherein the storage module stores driving data from repetitive journeys of travel routes or control data from repetitive workflows and can be retrieved based on a query input, (ii) providing a query input to the storage module regarding a predetermined travel route or a predetermined workflow, and (iii) specializing the trained machine learning model by retraining it based on the driving data stored in the storage module for the predetermined travel route or based on the control data stored in the storage module for the predetermined workflow.

This application claims priority under 35 U.S.C. § 119 to application no. DE 10 2024 209 139.1, filed on Sep. 24, 2024 in Germany, the disclosure of which is incorporated herein by reference in its entirety.

The disclosure relates to a method and an apparatus for specializing a trained machine learning model for providing a driving function of a vehicle or a control function of a machine. The disclosure also relates to a computer program with program code, a computer-readable data carrier, a control unit and a cloud.

### BACKGROUND

Autonomous driving technology has made considerable progress with the advent of deep learning techniques. However, the current paradigm relies on models that are trained to solve single tasks or on multi-task learning (MTL) approaches, which can lead to information loss, error accumulation and functional mismatch. In contrast, end-to-end autonomous driving systems aim to combine perception, prediction and planning, where the selection and prioritization of previous tasks remains crucial for effective planning.

Intelligence is closely linked to human memory, as our ability to recall and use past experiences is crucial for even the simplest tasks. On the way to work or home, people generally rely less on their cognitive abilities and more on their memory, as the familiar surroundings and routine make navigation easier. Known routes, familiar landmarks and/or predictable traffic patterns create a kind of memory bank that allows us to function to a certain extent as an autopilot.

The driving scenario of commuting between work and home provides a wealth of data that can be used to optimize the driving experience. By using this data, for example, a deep learning model can be developed that incorporates memory information and specializes in a specific routine route.

Several studies have already dealt with the use of a deep learning model with memory. However, these methods focus on representation learning and have not been used for the overall development of an end-to-end autonomous driving system. Exemplary approaches are known from CN 108 897 313 A and US 2019/0 332 109 A1.

It is therefore a problem addressed by the disclosure to provide an improved method and/or improved apparatus.

The problem is solved by a method according to the features set forth below. The problem is solved by an apparatus according to the features also set forth below.

### SUMMARY

According to a first aspect, a method for specializing a trained machine learning model for providing a driving function of a vehicle or a control function of a machine is proposed. The method comprises the following steps:
providing the trained machine learning model, which is trained on the basis of driving data from the vehicle or control data from the machine to perform the driving function or the control function, and which is extended by a storage module, wherein the storage module stores driving data from repetitive journeys of travel routes or control data from repetitive workflows and can be retrieved based on a query input;
providing a query input to the storage module regarding a predetermined travel route or a predetermined workflow;
specializing the trained machine learning model by retraining it based on the driving data stored in the storage module for the predetermined travel route or based on the control data stored in the storage module for the predetermined workflow, and
providing the specialized machine learning model for providing a driving function of the vehicle specialized based on the predetermined travel route or a control function of the machine specified based on the predetermined workflow.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without going beyond the scope of the method according to the disclosure.

According to a second aspect, an apparatus for specializing a trained machine learning model for providing a driving function of a vehicle or a control function of a machine is proposed. The apparatus comprises an evaluation and calculation unit that is configured to perform the following steps:
providing the trained machine learning model, which is trained on the basis of driving data from the vehicle or control data from the machine to perform the driving function or the control function, and which is extended by a storage module, wherein the storage module stores driving data from repetitive journeys of travel routes or control data from repetitive workflows and can be retrieved based on a query input;
providing a query input to the storage module regarding a predetermined travel route or a predetermined workflow;
specializing the trained machine learning model by retraining it based on the driving data stored in the storage module for the predetermined travel route or based on the control data stored in the storage module for the predetermined workflow, and
providing the specialized machine learning model for providing a driving function of the vehicle specialized based on the predetermined travel route or a control function of the machine specified based on the predetermined workflow.

The explanations given for the method apply to the apparatus accordingly. In this regard, any linguistic modifications of features formulated in terms of the method can be reformulated for the apparatus in accordance with standard linguistic practice, without such formulations having to be explicitly listed here.

The trained model is preferably provided by a preceding initialization. During this initialization, a nominal model without a storage module is preferably trained on a large data set of driving data or control data in order to be generically applicable for driving functions or control functions. After convergence, the trained model is able to perform well on any route or in any workflow (which was mapped in the training data). This phase allows the model to generalize.

The model trained in this generalized way is then further specialized. Using the trained generalist model, the model with the storage module, which can also be referred to as an AI-based storage module, is trained specifically for a predetermined route, such as a commute, or a predetermined workflow. This step enables the model to specialize in this predetermined route or the predetermined workflow. This means that the specialized model achieves better results on the predetermined route or in the predetermined workflow than the generalist model.

In this document, the terms “machine learning model”, “deep learning model” and “model” are used synonymously. The storage module preferably provides a kind of memory for the model. The storage module preferably stores geographical knowledge or previous knowledge from past model applications, for example from past repetitive driving or past repetitive workflows.

The present disclosure provides improved model performance. By using a deep learning model with a storage module that mimics (geographical) memory, the system can continuously learn and adapt to the unique nuances of a repetitive route or repetitive workflow, for example. This allows the model to determine information based on, for example, real-time traffic conditions, road closures, traffic situation, road closures and/or other factors, ensuring a faster and smoother journey.

The present disclosure also enables a personalized driving experience. The integration of the storage module into the deep learning model makes it possible to recall previous experiences and learn from the driver's individual preferences. As a result, the system can tailor a driving experience to the specific needs and preferences of the user. It can adjust factors such as the preferred speed and thus enable a personalized and comfortable ride.

The present disclosure also enables the provision of proactive safety measures. The deep learning model with the storage module can analyze and learn from previous journeys to identify potential hazards and mitigate risks. By using the (geographical) knowledge stored in the storage module, the system can retrieve past near-accidents or dangerous situations and learn from them so that it can make better-informed decisions while driving. This proactive approach increases road safety by helping to prevent accidents and warning drivers of potential dangers in advance.

The present disclosure also enables adaptive driver assistance. Another advantage of including the storage module in the deep learning model is its ability to adapt to the driver's abilities and preferences. By remembering past driving experiences, the system can offer personalized support, e.g., driving tips, suggestions for optimal driving techniques, and/or alerting the driver to possible blind spots. This adaptive driver assistance helps to improve driving skills, increase confidence in assisted driving and reduce the likelihood of errors and/or accidents.

The present disclosure also makes it possible to optimize fuel efficiency. The deep learning model with storage module can also help to optimize fuel efficiency on the journey between home and work. By learning from previous journeys, the system can recognize patterns in fuel consumption and suggest adjustments to driving habits and/or route selection that can lead to fuel savings. This not only benefits the environment, but also helps the driver to save fuel costs.

The present disclosure also enables continuous learning and improvement of assisted or autonomous driving. The deep learning model with storage module has the ability to continuously learn and improve its performance over time. As it collects more data with every journey, it can refine its decision-making processes, adapt to changing road conditions and thus improve the overall driving experience. This continuous learning ensures that the model always remains up-to-date in terms of traffic patterns and/or road infrastructure, leading to a constant improvement in performance and efficiency.

The present disclosure provides a method for utilizing (extensive) data on commuting between home and work. In this way, an end-to-end autonomous driving system can be provided that is able to specialize in a specific (routine) route. On such a route, the model can then outperform a generalist model that is not optimized for any specific route.

Given the extensive availability of data and the practicality of the solution, it is clear that incorporating memory into a deep learning model can significantly improve its performance and effectiveness, particularly in the area of autonomous driving. A type of commuter mode is proposed here. Commuter mode refers to the collection and use of data that is generated when traveling the same route several times. The present disclosure relates to the use of commuter mode for the development of an end-to-end deep learning driving system with neural memory.

The disclosure can be used in various areas. In particular, existing and future driver assistance systems and automated driving functions, e.g. PACE, Halfdome, Athena, can be optimized by the disclosure. Applications in other areas such as robotics or safety technology are also conceivable. In general, the disclosure can be integrated into all products that require intelligent automation.

In a further aspect, it is proposed that the storage module comprises a neural storage device, in particular a neural storage network.

It is proposed to extend the model architecture by providing the storage module in order to provide the model with a kind of memory for the predetermined route or the predetermined workflow. The storage module can be a neural storage. This storage module can be designed as a series of dense grids as in NERF. However, the design of such a module is not limited to this.

In a further aspect, it is proposed that the query input comprises geographic information relating to the predetermined travel route or geographic or temporal or other information relating to the predetermined workflow.

The storage module can receive, for example, a localization input or geographic information and, based on this, retrieve the driving data or control data from the storage module in a latent space and make it available to the model for specialization. This latent space may contain information such as a static perception of the environment, lane information, trends in the motion trajectory of other agents, trends in the motion trajectory of the self-driving vehicle or self-driving machine, and/or a preferred speed. This information is intended to promote safe driving or safe workflow.

In a further aspect, it is proposed that the machine learning model comprises several submodules, in particular a detection submodule, an estimation submodule, and a planning submodule.

Such a structure of the model corresponds to an exemplary architecture of an end-to-end driving system or an end-to-end control system of a machine. The model comprises large neural networks with several submodules. These submodules can have detection or perception modules and/or estimation or prediction modules and/or planning modules and/or monitoring or control modules. These neuronal submodules preferably share the latent spaces so that the system can be trained in an end-to-end method. With the ability to learn directly from data, the model can capture complex relationships and patterns that are difficult to model using conventional methods. This design can also significantly shorten the development time for autonomous driving systems or control systems. By eliminating manual function creation and complex module integration, developers can focus more on data collection and model training, which speeds up the entire development process.

In a further aspect, it is proposed that the driving data and/or the control data comprise geographical information and/or sensor data, in particular lidar sensor data and/or radar sensor data and/or camera sensor data and/or SD card sensor data and/or ultrasonic sensor data.

Other input data and/or metadata are also conceivable, so that this list is not to be understood as restrictive.

In a further aspect, a control unit is comprised in a vehicle having an autonomous driving function and/or a robotic system and/or an industrial machine, and on which the present method is executable in one of its aspects. The control unit of the vehicle or machine is designed to execute the specialized machine learning model, which has been specialized according to the present method, in order to provide the specialized driving function of the vehicle based on the predetermined travel route or the specified control function of the machine based on the predetermined workflow, and is preferably configured to retrain the specialized machine learning model based on real-time data of the predetermined travel route or the predetermined workflow, in particular continuously or at intervals.

The continuous or intermittent (re)training of the model can therefore also take place directly on the edge device responsible for executing the model in inference. For example, if a vehicle travels the same travel route several times, the model is executed in the background and can be retrained directly on the vehicle's or machine's control unit using the vehicle's live data and/or model output data generated on the basis of this live data. This approach is efficient because a continuously updated model is available for the predetermined travel route or workflow. For example, it is also possible to react to new circumstances on the route or in the workflow. If, for example, there is a construction site or obstacle on the predetermined travel route that is always present when driving the travel route multiple times, the model can be adapted to these changed conditions.

In a further aspect, a cloud is also disclosed below for a vehicle or a machine. The cloud is designed to receive real-time data on the predetermined travel route or predetermined work process from the vehicle or machine, to execute the specialized machine learning model that has been specialized according to the present method, and to retrain it on the basis of the real-time data, in particular continuously or at intervals, and to provide the retrained, specialized machine learning model to the vehicle or machine for providing the driving function specialized based on the predetermined travel route or the control function specified based on the predetermined workflow.

In this case, it is also possible to train the machine learning model extended by the storage module in the cloud, for example if the storage and/or computing resources of the vehicle and/or machine are insufficient to enable retraining of the model. During the journey with the vehicle on the predetermined travel route, the (sensor and/or other meta) data provided to the model as input data and the output data generated by the model are uploaded to the cloud. For example, once sufficient data has been uploaded, the training of the already specialized model is performed again based on the new data, enabling online adaptation or continuous renewal of the model.

In a further aspect, a computer program comprising program code is disclosed for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier comprising program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The described embodiments and refinements may be combined with one another as desired.

Further possible embodiments, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

FIG. 1 shows a schematic flowchart of an exemplary embodiment of the method.

FIG. 2 a schematic block diagram of an exemplary embodiment of the device.

In the figures of the drawings, identical reference numbers denote identical or functionally identical elements, parts or components, unless stated otherwise.

### DETAILED DESCRIPTION

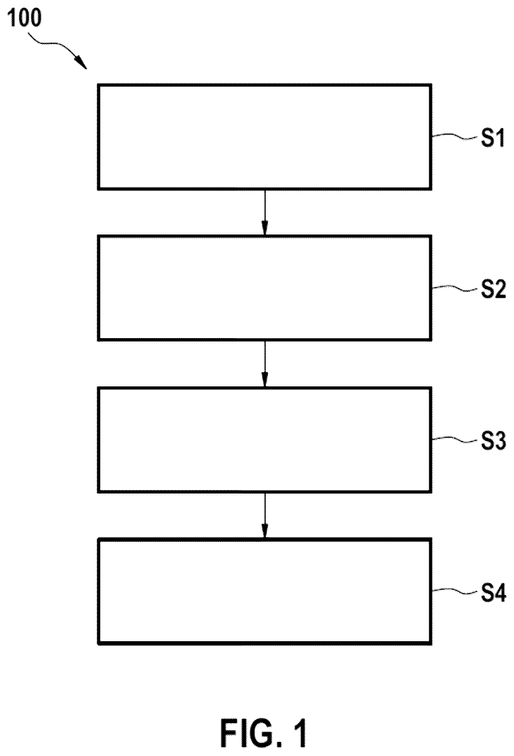

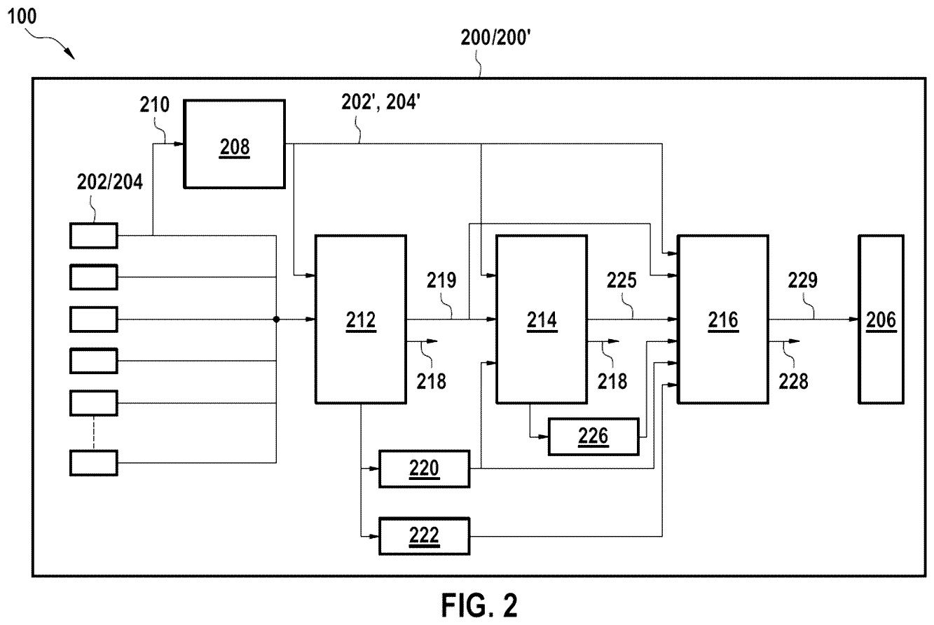

FIG. 1 shows a schematic flowchart of a method for specializing a trained machine learning model to provide a driving function of a vehicle or a control function of a machine. The method is also explained with reference to FIG. 2, which shows a schematic block diagram of an exemplary embodiment of an apparatus 100.

The method can be carried out in any embodiment, at least in part, by the device 100 which may comprise several components not shown in detail, for example one or more provision devices and/or at least one evaluation and calculation unit. It is understood that the provision device may be configured so as together with the evaluation-and-calculation unit or may be different from it. Furthermore, the apparatus 100, which may be part of a system, may comprise a storage device and/or an output device and/or a display device and/or an input device.

The computer-implemented method comprises at least the following steps:

In step S1, the trained machine learning model 200 is provided, which is trained on the basis of driving data 202 from the vehicle or control data 204 from the machine to execute the driving function or the control function by way of a control unit 206, and which is extended by a storage module 208, wherein driving data from repetitive journeys of travel routes or control data from repetitive workflow are stored in the storage module 208 and can be retrieved based on a query input 210. The storage module 208 comprises a neural storage, in particular a neural storage network.

In step S2, a query input relating to a predetermined travel route or a predetermined workflow is provided to the storage module 208. The query input includes, for example, geographic information about the predetermined travel route or geographic, temporal, or other information about the predetermined workflow.

In step S3, the trained machine learning model is specialized by retraining it based on the driving data 202′ stored in the storage module 208 for the predetermined travel route or based on the control data 204′ stored in the storage module 208 for the predetermined workflow.

In step S4, the specialized machine learning model 200′ is provided to provide a driving function of the vehicle specialized based on the predetermined travel route or a control function of the machine specified based on the predetermined workflow.

The trained machine learning model 200 or the specialized machine learning model 200′ comprises several submodules 212, 214, 216. In the present case, the trained machine learning model 200 or the specialized machine learning model 200′ comprises a detection submodule 212, an estimation submodule 214, and a planning submodule 216.

The detection submodule 212 captures, taking into account an acquisition loss 218, correlations 219 in the driving data 202 or in the control data 204, which serve as input data for the capturing submodule 212. Furthermore, the detection submodule 212 generates perception information 220 in the latency space and a local map 222. In the present case, the detection submodule 212 for specifying also receives as input data the driving data 202′ stored in the storage module 208 for the predetermined travel route or the control data 204′ stored in the storage module 208 for the predetermined workflow.

The estimation submodule 214 receives as input data for specification the driving data 202′ stored in the storage module 208 for the predetermined travel route or the control data 204′ stored in the storage module 208 for the predetermined workflow. Furthermore, the estimation submodule 214 receives the output data 219 generated by the detection submodule 212 as input data. The estimation submodule 214 generates an estimate 225 of a possible driving function or a possible control function based on the input data, taking into account an estimation loss 224. Further, the estimation submodule 214 generates estimation information 226 in the latency space.

The planning submodule 216 receives as input data for specification the driving data 202′ stored in the storage module 208 for the predetermined travel route or the control data 204′ stored in the storage module 208 for the predetermined workflow. Furthermore, the planning submodule 216 receives the output data 225 from the estimation submodule 214 as well as the perception information 220 in the latency space and the local map 222, i.e., input data, and, taking into account a planning loss 228, generates planning information 229, on the basis of which the driving function or the at least one control function is activated by the control unit 206.

What is claimed is:

1. A method for specializing a trained machine learning model for providing a driving function of a vehicle or a control function of a machine, the method comprising:
providing the trained machine learning model, which is trained on the basis of driving data from the vehicle or control data from the machine to perform the driving function or the control function, and which is extended by a storage module, wherein the storage module stores driving data from repetitive journeys of travel routes or control data from repetitive workflows and can be retrieved based on a query input;
providing a query input to the storage module regarding a predetermined travel route or a predetermined workflow;
specializing the trained machine learning model by retraining it based on the driving data stored in the storage module for the predetermined travel route or based on the control data stored in the storage module for the predetermined workflow, and
providing the specialized machine learning model for providing a driving function of the vehicle specialized based on the predetermined travel route or a control function of the machine specified based on the predetermined workflow.

2. The method according to claim 1, wherein the storage module comprises a neural storage.

3. The method according to claim 1, wherein the query input comprises geographic information about the predetermined travel route or geographic or temporal or other information about the predetermined workflow.

4. The method according to claim 1, wherein the machine learning model comprises several submodules.

5. The method according to claim 1, wherein the driving data and/or the control data comprise geographical information and/or sensor data.

6. A computer program having program code to execute at least portions of a method according to claim 1 if the computer program is executed on a computer.

7. A computer-readable data carrier having program code of a computer program to execute at least portions of a method according to claim 1 if the computer program is executed on a computer.

8. A control unit of a vehicle or a machine, which is designed to execute the specialized machine learning model that has been specialized according to the method of claim 1 in order to provide the driving function of the vehicle specialized on the basis of the predetermined travel route or the control function of the machine specified on the basis of the predetermined workflow, and which is configured to retrain the specialized machine learning model based on real-time data of the predetermined travel route or the predetermined workflow, continuously or at intervals.

9. A cloud for a vehicle or machine that is designed to receive real-time data of the predetermined travel route or the predetermined workflow from the vehicle or machine, execute the specialized machine learning model that has been specialized according to the method of claim 1, and retrain it based on the real-time data, continuously or at intervals, and to provide the retrained, specialized machine learning model to the vehicle or machine for providing the driving function specialized based on the predetermined travel route or the control function specified based on the predetermined workflow.

10. An apparatus for specializing a trained machine learning model for providing a driving function of a vehicle or a control function of a machine, wherein the apparatus comprises an evaluation and calculation unit that is designed to perform the following:
providing the trained machine learning model, which is trained on the basis of driving data from the vehicle or control data from the machine to perform the driving function or the control function, and which is extended by a storage module, wherein the storage module stores driving data from repetitive journeys of travel routes or control data from repetitive workflows and can be retrieved based on a query input;
providing a query input to the storage module regarding a predetermined travel route or a predetermined workflow;
specializing the trained machine learning model by retraining it based on the driving data stored in the storage module for the predetermined travel route or based on the control data stored in the storage module for the predetermined workflow; and
providing the specialized machine learning model for providing a driving function of the vehicle specialized based on the predetermined travel route or a control function of the machine specified based on the predetermined workflow.

11. The method according to claim 2, wherein the neural storage is a neural storage network.

12. The method according to claim 4, wherein the several submodules include a detection submodule, an estimation submodule, and a planning submodule.

13. The method according to claim 5, wherein the sensor data includes lidar sensor data and/or radar sensor data and/or camera sensor data and/or SD card sensor data and/or ultrasonic sensor data.
